(19) United States
(12) Patent Application Publication
(10) Pub. No.: US 2016/0139703 A1
(43) Pub. Date: May 19, 2016

(54) STRUCTURE FOR TOUCH ELECTRODE SUBSTRATE AND MANUFACTURING METHOD THEREOF

(71) Applicant: T-Kingdom Co., Ltd., Zhongli (TW)

(72) Inventor: Hsin-Lun TSAI, Zhongli City (TW)

(73) Assignee: T-Kingdom Co., Ltd., Zhongli (TW)

(21) Appl. No.: 14/548,272

(22) Filed: Nov. 19, 2014

(51) Int. Cl. G06F 3/044

(52) U.S. Cl. CPC G06F 3/044; G09G 2300/04

(57) ABSTRACT

The present invention provides a method for manufacturing a touch electrode substrate, including the steps of (A) selecting a preset substrate for forming a substrate layer; (B) forming a conductive layer on at least one surface of the substrate layer; (C) depositing a photoresist on the conductive layer, performing a first exposure, and forming a first exposure pattern on the conductive layer; (D) performing a second exposure on the conductive layer, and forming a second exposure pattern on the conductive layer; (E) forming a shielding layer that has a circuit pattern, by means of developing the first exposure pattern and the second exposure pattern; and (F) processing the conductive layer and the shielding layer, to enable the conductive layer to form a plurality of metal circuits on at least one surface of the substrate layer. Therefore, the present invention may provide the same or different dimensions of the touch electrode substrate having the same circuit patterns by using a low-cost soft plastic film photomask, and may enable other companies to carry out subsequent processing of the plurality of connection circuits.

### FIELD OF THE INVENTION

The present invention relates generally to a structure of a touch electrode substrate and a method for manufacturing the same, and more particularly, the present invention relates to a substrate structure having predetermined metal circuits that are produced by two successive exposure procedures, and that is used in touch electronic products, so as to enable other companies to do subsequent processing and design.

### BACKGROUND OF THE INVENTION

In accordance with conventional processes that manufacture a touch electrode substrate, the touch sensing electrode pattern having conductive traces is manufactured by means of a printing process, electroplating process or an etching process together with the materials that include metals.

Nowadays, in general, the presence or absence of the finger of a user touching a sensing surface of a touch screen of an electronic product is detected in accordance with the touching detection regions, the electrical signals and the capacitance changes between the conductive traces. The conductive traces that have different routing directions may be connected to the external connection circuits. The electrical sensing signals may be transmitted to other processing units through the external connection circuits that are connected to other electronic circuit boards and IC chips of the electronic product having a touch screen.

Generally, in accordance with the screen printing process, the aforesaid external connection circuits are implemented by printing the external portions of the conductive traces with materials having metal powers on the external connection circuits that are connected to the conductive traces. However, since the width of the connection circuits that are manufactured by the screen printing process may be wider, these wider connection circuits are seldom applied to the electronic touch sensing products that have a touch screen. Additionally, with the use of the materials, the wider connection circuits may have high impedance value due to high parasitic resistance, and have inferior folding endurance (bendable elastic).

Moreover, in accordance with the conventional manufacturing approaches, as to the touch electrodes having electrode patterns, the conductive traces and the connection circuits are integrally formed on a surface of a glass substrate or a plastic subtract by means of using one of the screen printing, electroplating, sputtering and etching processes.

Although the aforesaid manufacturing approaches may enhance the alignment between the conductive traces and the connection circuits, the precise conductive traces and the wide connection circuits still cannot be manufactured at the same time since the implementation of the width of the conductive traces and the connection circuits is quite difficult to control. In addition, during the manufacturing processes, each of the electrode patterns may be manufactured by means of using the expensive precise glass photomask manufacturing process. Accordingly, the cost of manufacturing the touch sensing electrodes having the conductive traces and the connection circuits cannot be reduced by means of integrally forming the conductive traces and the connection circuits.

### SUMMARY OF THE INVENTION

The primary objective of the present invention is to provide a touch electrode substrate that can be used in touch electronic products. In particular, the primary objective of the present invention includes the formation of a plurality of conductive circuits having a preset circuit pattern, by means of using the low cost and soft plastic photomask to aid the single precise glass photomask. The other primary objective of the present invention involves the formation of a predetermined flat region surrounding the plurality of metal circuits having the circuit pattern.

The other objective of the present invention is to provide a touch electrode substrate that will be used in touch electronic products. The conductive circuit of the preset metal lattice together with the surroundings of the plurality of conductive circuits may enable the other companies to connect the other subsequent plurality of conductive circuits, by means of using existing equipment and processes.

Yet another objective of the present invention may involve the collective formation of a circuit pattern through the use of a single precise glass photomask, low cost soft plastic film photomask and two continuous exposure procedures. The present invention also involves the manufacturing of a plurality of conductive circuits that has very precise circuits and also has a lattice structure, through the use of the electroplating and/or etching process concomitantly.

Still another objective of the present invention may involve the collective formation of a circuit pattern by using only a single precise glass photomask and a low cost and soft plastic film photomask that have the same or different circuit patterns, concomitantly with two continuous exposure processes. The formation of the above-mentioned circuit patterns may enable the surface of the manufactured touch electrode substrate to form a plurality of conductive circuits that has a different preset size and having the same circuit patterns.

In order to achieve the aforesaid objective, a structure for a touch electrode substrate of the present invention may include a substrate layer; and a conductive layer formed on a surface of the substrate layer, wherein the conductive layer includes a first region and a second region that is adjacent to the first region, and wherein the first region includes at least one of a plurality of metal circuit blocks, and each of the plurality of metal circuit blocks includes a plurality of metal circuits that has a circuit pattern. In accordance with a preferred embodiment of the present invention, the plurality of metal circuit blocks are mutually arranged and spaced. In one preferred embodiment of the present invention, the second region is set to represent a flat block.

In one aspect of the present invention, the plurality of metal circuits may be connected to a plurality of conductive electrodes. The plurality of conductive electrodes may include: at least an adhesion layer that forms a circuit pattern on the surface of the substrate layer; and a metal conductive electrode layer that is connected to the surface of the adhesion layer, and that corresponds to the circuit pattern.

Preferably, in accordance with a preferred embodiment of the present invention, the surface of the plurality of metal circuits of the first region includes a first weather resistant layer. In accordance with another preferred embodiment of the present invention, the first weather resistant layer includes an n-shaped structure. In one preferred embodiment of the present invention, a second weather-resistant layer is formed on a surface of the second region.

Preferably, an aspect of the present invention may further include the plurality of metal circuits having a lattice pattern; and in accordance with a preferred embodiment of the present invention, each of the plurality of metal circuits has a width of 0.5 μm to 10 μm.

In addition, in accordance with the embodiments of the present invention, the companies who purchase and/or use the present invention may be able to carry out subsequent processing, to connect at least one of a plurality of connection circuits to the surface of the second region. In other words, the companies may subsequently further enable a plurality of connection circuits including a circuit pattern that is also able to be electrically connected to the plurality of metal circuits of the first region. The design of the electrical connection of the plurality of connection circuits to the other circuit board or chip located at the same places within the touch electronic products may enable the present invention to have a flexible design in touch electronic products.

Moreover, in accordance with the preferred embodiments of the present invention, the method for manufacturing a touch electrode substrate may include the steps of (A) selecting a preset substrate for forming a substrate layer; (B) forming a conductive layer on at least one surface of the substrate layer; (C) depositing a photoresist on the conductive layer, performing a first exposure, and forming a first exposure pattern on the conductive layer; (D) performing a second exposure on the conductive layer, and forming a second exposure pattern on the conductive layer; (E) forming a shielding layer that has a circuit pattern, by means of developing the first exposure pattern and the second exposure pattern; and (F) processing the conductive layer and the shielding layer, to enable the conductive layer to form a plurality of metal circuits on at least one surface of the substrate layer. In an aspect of the present invention, the step (F) of the present invention may further include the formation of a weather-resistant layer on the surfaces of the plurality of metal circuits and the conductive layer.

In a preferred embodiment of the present invention, if the step (C) of the method the present invention uses a negative photoresist, then the step (F) of the method of the present invention may include the formation of a plurality of metal circuits by etching on a region that is outside of the shielding layer of the conductive layer.

In a preferred embodiment of the present invention, if the step (C) of the method of the present invention uses a positive photoresist, then the step (F) of the method of the present invention may include the formation of a plurality of metal circuits having the circuit pattern between the shielding layers, and further etching the conductive layer that is covered by the shielding layer after removing the shielding layer.

In a preferred embodiment of the present invention, the step (C) and the step (D) of the method of the present invention may include the steps of performing a process of the first exposure by means of a precise glass photomask, and performing a process of the second exposure by means of a plastic film photomask. In addition, in accordance with a preferred embodiment of the present invention, the step (C) and the step (D) of the method of the present invention may include the steps of performing a process of the first exposure by means of a plastic film photomask, and performing a process of the second exposure by means of a precise glass photomask.

For example, in accordance with a preferred embodiment of the present invention, repeating the step (B) to the step (F) of the method of the present invention on the lower surface 22 of the substrate layer of the step (B) of the method may enable the formation of a double-sided touch electrode substrate.

It is therefore clear from the foregoing that the special distinguishing technical features of the present invention include: the design of two continuous exposure processes, the concomitant use of a single precise glass photomask together with a number of low cost and soft plastic film photomasks that have the same or different sizes, and/or that have the same or different circuit patterns, which may enable the present invention to manufacture a plurality of metal circuits that has a preset circuit pattern. In addition, the companies that purchase and/or use the structure of the touch electrode substrate of the present invention may also be able to carry out additional subsequent processing of the plurality of connection circuits, at the flat region surrounding the plurality of metal circuits. To put it another way, the structure of the touch electrode substructure of the present invention may enable flexibility of any subsequent processing, also enabling the connection to the corresponding positions of the other circuit boards, connection circuits or chips in electronic products to be non-limiting. Moreover, the applicability of the present invention in touch electronic products may be significantly increased.

### BRIEF DESCRIPTION OF THE DRAWINGS

The present invention can be understood in more detail by reading the subsequent detailed description in conjunction with the examples and preferred embodiments made to the accompanying drawings, wherein:

FIGS. 1A and 1B are schematic diagrams illustrating the structure of a touch electrode substrate in accordance with the first and second preferred embodiments of the present invention.

FIG. 2A represents a cross-sectional schematic diagram corresponding to FIG. 1A in accordance with the first preferred embodiment of the present invention.

FIG. 2B is a schematic diagram corresponding to FIG. 2A that includes a structure of a weather-resistant layer in accordance with the first preferred embodiment of the present invention.

FIG. 3A represents a cross-sectional schematic diagram corresponding to FIG. 1B in accordance with the second preferred embodiment of the present invention.

FIG. 3B is a schematic diagram corresponding to FIG. 3A that includes a structure of a weather-resistant layer in accordance with the second preferred embodiment of the present invention.

FIGS. 4A to 4D are schematic diagrams illustrating the structure of the touch electrode substrate having a one-sided plurality of metal circuits with a plurality of connection circuits to be processed in accordance with the present invention.

FIGS. 5A to 5D are schematic diagrams illustrating the structure of the touch electrode substrate having a double-sided plurality of metal circuits with a plurality of connection circuits to be processed in accordance with the present invention.

FIG. 6 is a flow chart illustrating a method for manufacturing a touch electrode substrate in accordance with the first preferred embodiment of the present invention.

FIG. 7 is a flow chart illustrating a method for manufacturing a touch electrode substrate in accordance with the second preferred embodiment of the present invention.

FIGS. 8A and 8B are flow charts illustrating a method for manufacturing a touch electrode substrate in accordance with the third preferred embodiment of the present invention.

FIGS. 9A and 9B are flow charts illustrating a method for manufacturing a touch electrode substrate in accordance with the fourth preferred embodiment of the present invention.

FIG. 10 is a flow chart illustrating a method for manufacturing a touch electrode substrate in accordance with the fifth preferred embodiment of the present invention.

FIG. 11 is a flow chart illustrating a method for manufacturing a touch electrode substrate in accordance with the sixth preferred embodiment of the present invention.

FIGS. 12A and 12B are flow charts illustrating a method for manufacturing a touch electrode substrate in accordance with the seven preferred embodiment of the present invention.

FIGS. 13A and 13B are flow charts illustrating a method for manufacturing a touch electrode substrate in accordance with the eight preferred embodiment of the present invention.

FIGS. 14A to 14D are schematic diagrams illustrating the processing of a plurality of connection circuits corresponding to FIGS. 6 and 10, respectively, in accordance with the preferred embodiments of the present invention.

FIGS. 15A to 15D are schematic diagrams illustrating the processing of a plurality of connection circuits corresponding to FIGS. 7 and 11, respectively, in accordance with the preferred embodiments of the present invention.

FIGS. 16A to 16D are schematic diagrams illustrating the processing of a plurality of connection circuits corresponding to FIGS. 8A and 8B or FIGS. 12A and 12B, respectively, in accordance with the preferred embodiments of the present invention.

FIG. 17A to 17D are schematic diagrams illustrating the processing of a plurality of connection circuits corresponding to FIGS. 9A and 9B or FIGS. 13A and 13B, respectively, in accordance with the preferred embodiments of the present invention.

### DETAILED DESCRIPTION OF THE PREFERRED EMBODIMENT

The accompanying drawings are included to provide a further understanding of the invention, and are incorporated in and constitute a part of this specification. The drawings illustrate the preferred embodiments of the invention and, together with the description, serve to explain the principles of the invention.

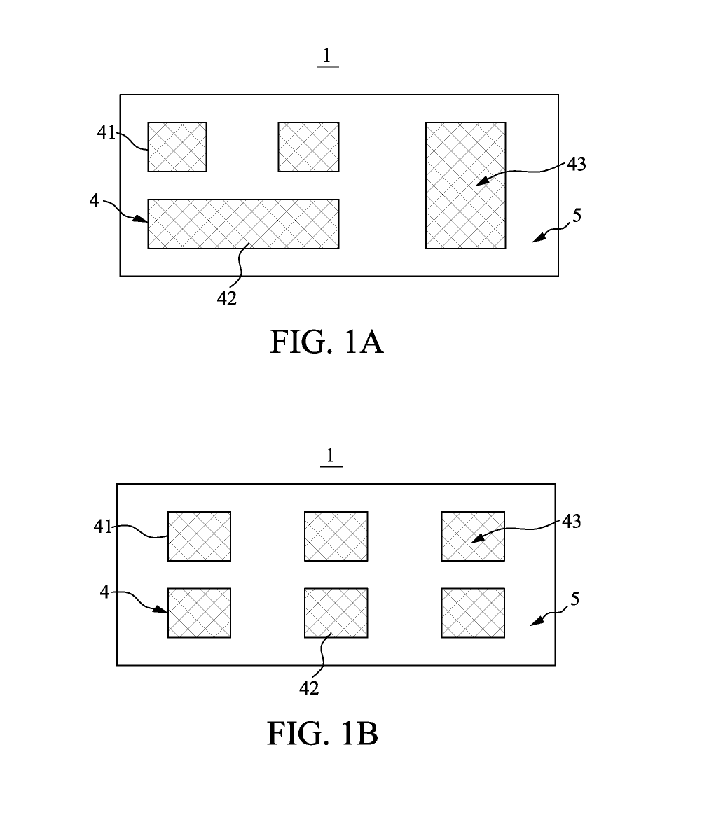

With regard to FIGS. 1-17, the drawings showing embodiments are semi-diagrammatic and not to scale and, particularly, some of the dimensions are for clarity of presentation and are shown exaggerated in the drawings. Similarly, although the views in the drawings for ease of description generally show similar orientations, this depiction in the drawings is arbitrary for the most part. Generally, the present invention can be operated in any orientation.

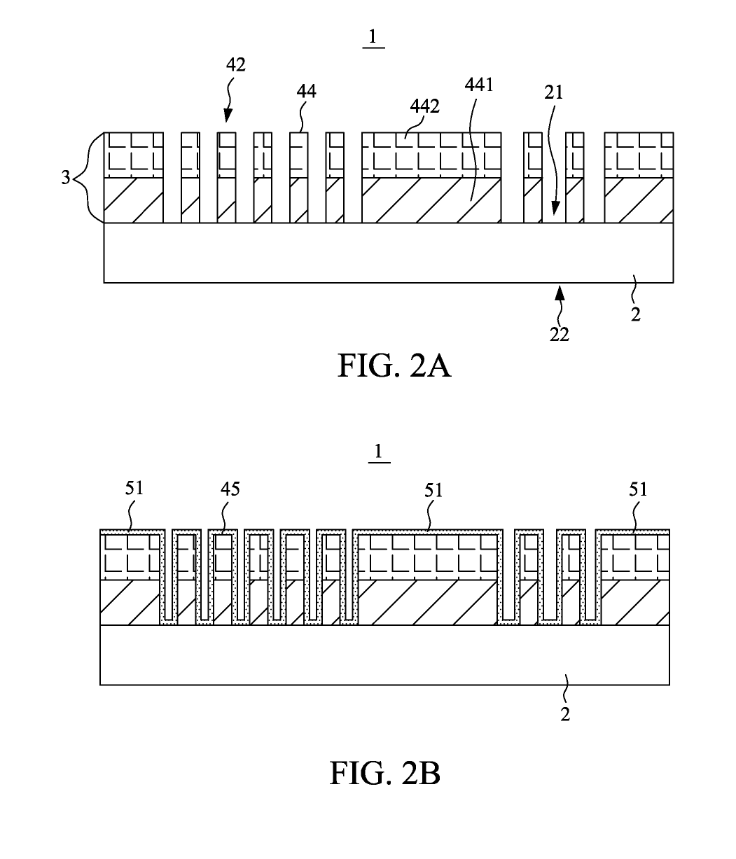

As shown in FIG. 1A, FIG. 2A and FIG. 2B, the touch electrode substrate structure 1 may be manufactured in accordance with the first preferred embodiment of the present invention. It mainly includes two layers such as a substrate layer 2 and a conductive layer 3. FIG. 1A represents the top view of a structure of the touch electrode substrate of the present invention, and FIG. 2A and FIG. 2B represent a cross-sectional schematic diagram of the structure of the touch electrode substrate of the present invention.

In accordance with the design of the present invention, the conductive layer 3 may be formed on one of the single surfaces of the substrate layer. That is, the conductive layer 3 may be formed on the upper surface 21 or lower surface 22, or may be formed at the same time on both the upper and lower surfaces of the substrate layer 2 (not shown in the drawings).

In accordance with a preferred embodiment of the present invention, the conductive layer 3 formed on the upper surface 21 of the substrate layer 2 may also be composed of a first region 4 and a second region 5. It is clear from the Fig. that the first region 4 may be composed of one metal circuit block or a plurality of metal circuit blocks 41. The plurality of metal circuit blocks may be mutually spaced from one another. Each of the plurality of metal circuit blocks 41 may include a plurality of metal circuits 42, and each of the plurality of metal circuit blocks 41 may respectively include the same circuit pattern. The design of the plurality of metal circuits 42 enables the plurality of metal circuits 42 to have a lattice 43 pattern.

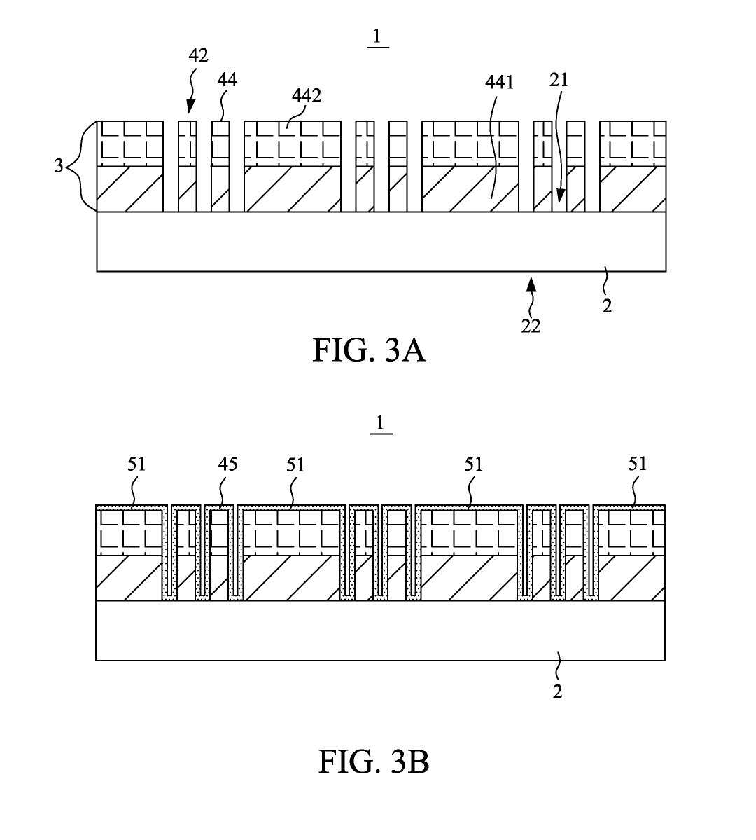

Referring to FIG. 1B, FIG. 3A and FIG. 3B, the structure for the touch electrode substrate 1 is illustrated in accordance with the second preferred embodiment of the present invention, whereby FIG. 1B represents the top view of the structure for the touch electrode substrate 1 of the present invention, and FIG. 3A and FIG. 3B are the cross-sectional schematic diagrams of the structure for the touch electrode substrate 1 of the present invention. The plurality of metal circuit blocks 41 of the first preferred embodiment may be different compared to the plurality of metal circuit blocks 41 of the second preferred embodiment. The difference lies in the fact that the plurality of metal circuit blocks 41 of the second preferred embodiment may have a different size compared to the plurality of metal circuit blocks 41 of the first preferred embodiment. Referring at the same time to FIG. 1A and FIG. 2A, it can be seen from these drawings that each of the plurality of metal circuit blocks 41 may have the same size. As such, the size of each of the plurality of metal circuit blocks 41 of the first region 4 may be designed in a manner such that each of the plurality of metal circuit blocks 41 may have the same size, or each of the plurality of metal circuit blocks 41 may have a different size, or that each of the plurality of metal circuit blocks 41 may have a size that is partially the same.

In addition, referring to FIG. 2A and FIG. 3A, the plurality of metal circuits 42 are connected to a plurality of conductive electrodes 44. Each of the plurality of conductive electrodes 44 may include: at least an adhesion layer 441. The adhesion layer 441 may form a circuit pattern on the upper surface 21 of the substrate layer 2, or on the lower surface 22 of the substrate layer 2, or may form a circuit pattern on both the upper surface 21 and lower surface 22 of the substrate layer 2. The plurality of conductive electrodes 44 may also include a metal conductive electrode layer 442, which is connected to the upper surface of the adhesion layer 441. The metal conductive electrode layer 442 may also correspond to the aforesaid circuit pattern.

Moreover, as shown in FIG. 2B and FIG. 3B, a weather-resistant layer is to protect the structure for the touch electrode substrate 1 of the present invention, and may be formed on either the upper surface 21 or the lower surface 22 of the structure for the touch electrode substrate 1. Or alternatively, the weather-resistant layer of the present invention may be formed on both the upper surface 21 and the lower surface 22 of the structure for the touch electrode substrate 1. In accordance with the different distribution positions of the weather-resistant layer, the weather-resistant layer may be classified as a first weather-resistant layer 45 which may be located on all of the surfaces of the plurality of metal circuits 42, and the first weather-resistant layer 45 may also have an ‘n’ shaped pattern. Furthermore, the second weather-resistant layer 51 may be located on the upper surface of the second region 5.

According to a preferred embodiment of the present invention, since the second region 5 may be designed to surround and to be adjacent to the outer periphery of the first region 4, as well as to show a flat pattern. As such, the second weather-resistant area may have a ‘-’ shape.

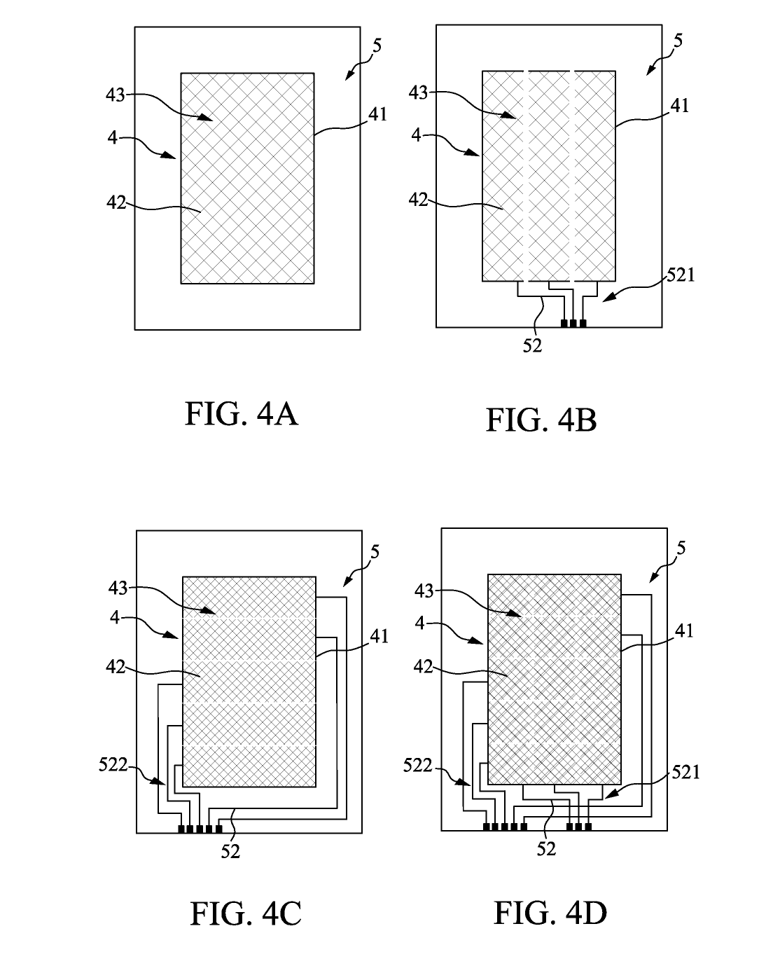

As shown in FIG. 4A to FIG. 4D, subsequent to manufacturing a structure for the touch electrode substrate 1 that has a single-sided plurality of metal circuits 42 or a double-sided plurality of metal circuits 42 in accordance with the manufacturing method illustrated in a preferred embodiment of the present invention, the companies that later purchase and/or use the present invention may carry out any subsequent processing based on of their own original equipment and processes. To put it another way, the following subsequent processing may be carried out once more—the first exposure procedure, the developing procedure and the etching procedure may be performed by etching along the X axis 521 or etching along the y axis 522 to form the plurality of connection circuits 52 and to remove the local area of the second region 5 at the same time besides the position of the set plurality of connection circuits 52. The etching of the original plurality of metal circuits 42 may be complete and may be shown as a lattice 43 pattern that may be a plurality of long strips or squares (referring to FIG. 4B to FIG. 4D). The plurality of connection circuits 52 may be used to connect to the other plurality of circuits or chips on the circuit board within the touch electronic products.

It is clear from FIG. 4A that the structure for the touch electrode substrate 1 of the present invention may have a single-sided plurality of metal circuits 42, and the plurality of metal circuits 42 may have the pattern of a single lattice.

As shown in FIG. 4B, the plurality of connection circuits 52 may be connection circuits that are connected to the plurality of metal circuits 42 along the x-axis 521. In addition, the plurality of connection circuits 52 may also be connection circuits that are connected to the plurality of metal circuits 42 along the y-axis 522.

Moreover, as shown in FIG. 4D, when two of the touch electrode substrates having a single-sided plurality of metal circuits 42 have been adhered to each other by means of an optically clear adhesive (OCA), a double-layered structure for the touch electrode substrate 1 having a dense distribution of the plurality of metal circuits 42 with the circuit pattern may be formed. Furthermore, the plurality of connection circuit 52 may be along the x-axis 521 and the y-axis 522 at the same time.

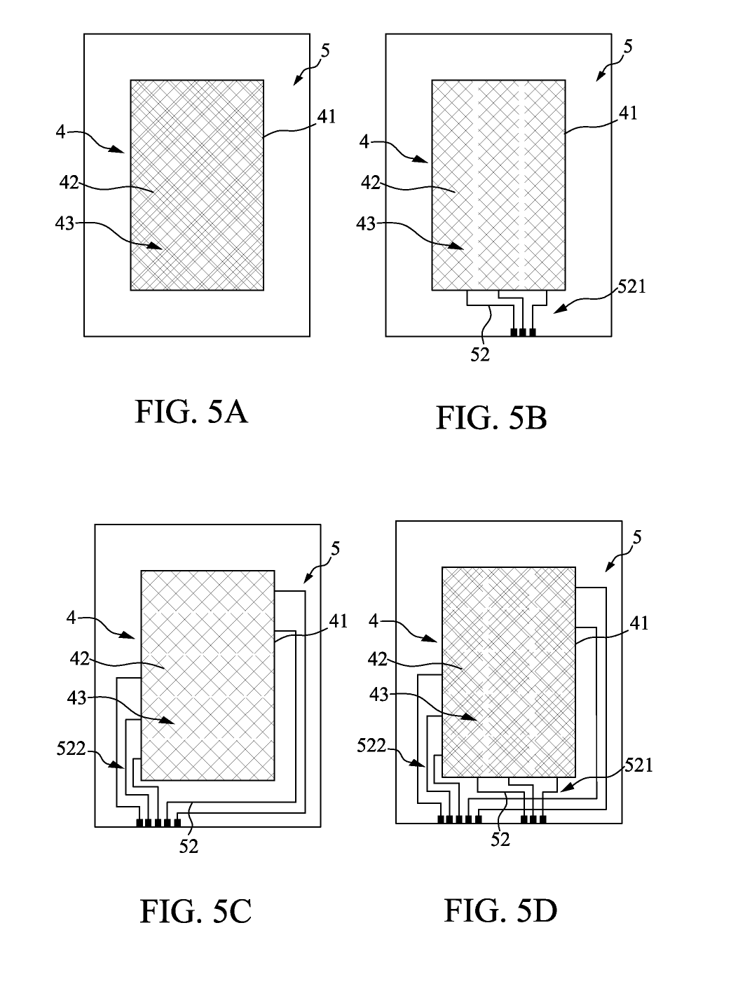

As shown in FIG. 5A to FIG. 5D, the structure for the touch electrode substrate 1 of the present invention is illustrated in accordance with the second preferred embodiment. FIG. 5A to 5D also illustrate the structure for the touch electrode substrate 1 having a double-sided plurality of metal circuits 42 with the circuit pattern that is manufactured subsequent to processing by companies that have purchased and/or used the present invention. The processing carried out by these companies may include processing that have been carried out for FIG. 3A to FIG. 3D. The difference between the structures of FIG. 5A to FIG. 5D lies in the fact that the structures of FIG. 4A to FIG. 4D have a double-sided plurality of metal circuits 42. In addition, as shown in FIG. 5B to FIG. 5D, the structure for the touch electrode substrate 1 that has a double-sided plurality of metal circuit 42 may be respectively processed, and thus leading to the formation along the x-axis which is located on the surface of the second region 5; or processing may lead to the formation along y-axis that is located on the surface of the second region 5. Or alternatively, the simultaneous processing of the structure of the present invention may lead to the formation of the plurality of connection circuits 52 along the x-axis 521, or lead to the formation of the plurality of connection circuit along the y-axis 522.

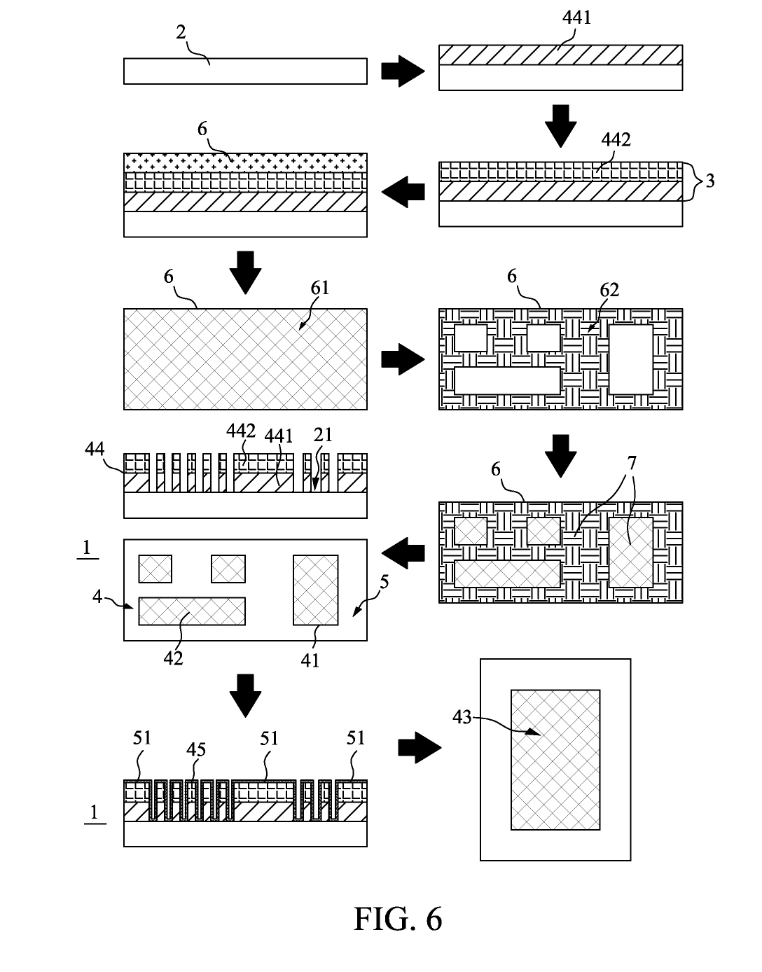

As shown in FIG. 6, the method for manufacturing the structure for the touch electrode substrate 1 of the present invention is illustrated in accordance with the first preferred embodiment of the present invention. The steps of the manufacturing method are as follows.

(A) a preset substrate may be selected for the formation of a substrate layer 2; (B) a conductive layer 3 may be formed on the upper surface 21 of the single surface of the substrate layer 2; (C) a negative photoresist 6 may be coated and adhered onto the upper surface of the conductive layer 3 by means of a coating method and a adhesive film. The photoresist 6 may be selected from a material selected from the group consisting of a dry film photoresist, or selected from a negative liquid photoresist material; a first exposure may be performed by means of covering a single precise glass photomask on the photoresist 6, and a first exposure pattern 61 may be formed on the upper surface of the conductive layer 3 by performing the first exposure. The precise glass used in the first exposure process may have the same circuit pattern, or may have different sized circuit patterns or may have different sized touch electrode substrate 1 of the present invention or may have different sized circuit patterns. Additionally, the plurality of touch electrode substrates 1 that have been produced after one complete production process may have the same circuit pattern, or may have the circuit patterns with the same size or different sizes. A first exposure pattern 61 having a predetermined circuit pattern may be formed by a bonding reaction between ultraviolet light and negative photoresist during the first exposure process.

In addition, according to a preferred embodiment of the present invention, the second exposure may be performed by means of a soft plastic film photomask on the conductive layer 3, and the second exposure pattern 62 may be formed on the upper surface of the conductive layer 3. The second exposure process may involve a step of performing the exposure by means of a soft plastic film photomask; and the exposure is performed within a pre-reserved photoresist range having a preset pattern. In addition, the second exposure process may also involve the formation of a second exposure pattern 62 via the subsequent bonding reaction with ultraviolet light. The second exposure pattern 62 may partially overlap with the first exposure pattern 61. Furthermore, the overlapping part of the second exposure pattern 62 and the first exposure pattern 61 is the predetermined part that will be reserved.

In accordance with a preferred embodiment of the present invention, (E) A developer (developing fluid) may be used to remove any non-exposed and shielded photoresist 6 from the first exposure pattern 61 and the second exposure pattern 62. In other words, the first exposure pattern 61 and the second exposure pattern 62 may be shown together, and to have a joint appearance, and thus collectively forming a shielding layer 7 that has a circuit pattern. The shielding layer 7 may include a part of the pre-reserved circuit pattern.

Furthermore, according to a preferred embodiment of the present invention, the step (F) of the method may involve re-etching regions other than the shielding layer 7 of the conductive layer 3, to enable the formation of a plurality of metal circuits 42. This in other words means placing the negative photoresist having a circuit pattern that has still been preserved subsequent to the developing process onto the upper surface 21 of the substrate layer 2. Moreover, the adhesion layer 441 that is not covered or shielded by the circuit pattern of the negative photoresist and the metal conductive electrode layer 442 will be removed at the same time by etching, through the use of an etching agent.

In accordance with the cross-section view of the touch electrode substrate 1 of the present invention, subsequent to two continuous exposure procedures, developing procedure and the etching procedure, the structure for the touch electrode substrate 1 of the present invention is formed as follows. A first region 4 that has a lattice 43 circuit pattern may be formed on the upper surface 21 of the substrate layer 2. The second region 5 that surrounds and is adjacent to the first region 4 may also be formed. The first region 4 is made up of a plurality of metal circuits 42 with different sizes. Relative to the first region 4, the second region 5 is the region that is shielded and covered by the negative photoresist, and the second region 5 is thus the region that is reserved and will not be removed by etching. In addition, the second region 5 appears to have a height that equals the height of the first region 4; and it is also in a flat and planar state.

Finally, according to a preferred embodiment of the present invention, a first weather-resistant layer 45 may be formed on all of the surfaces of the metal circuit 42 subsequent to electroplating, chemical plating deposition, or OSP, and a second weather-resistant layer 51 may be formed on the upper surface 21 of the substrate layer 2.

According to a preferred embodiment of the present invention, the distributed position of the first weather-resistant layer 45 may be for forming the ‘n’ shaped pattern on all of the surfaces of the metal circuit 42 of the first region 4. Relatively speaking, the second weather-resistant layer 51 may be formed on the upper surface of the second region 5, and may be presented as a ‘-’ pattern.

Also, in accordance with a preferred embodiment of the present invention, the materials of the first weather-resistant layer 45 and the second weather-resistant layer 51 may be selected from carbon, graphite, metals and metal oxides. Other materials that may be selected include conductive polymeric material, or one of a complex material, or the materials may also be selected from a complex material.

Additionally, it needs to be added that if the manufacturing steps in the step (F) of the present invention may be replaced with the steps as follows, the same structure for the touch electrode substrate 1 of the present invention may be manufactured: the negative photoresist in the step (C) of the present invention may be replaced with a positive photoresist; the shielding layer 7 that may be formed collectively by the first exposure pattern 61 and the second exposure pattern 62 may shield and cover the surface of the conductive layer 3 that is predetermined to be removed; and by means of the method of electroplating, the circuit pattern formed at the shielding layer 7 may form a conductive layer having metals; after the removal of the photoresist 6, an etching process may be used to partially remove the conductive layer 3 that has been covered and shielded by the shielding layer 7 and the original shielding layer 7.

As shown in FIG. 6, the structure for the touch electrode substrate 1 of the present invention is illustrated in accordance with the first preferred embodiment of the present invention. The metal circuit 42 of the touch electrode substrate 1 of the present invention may be formed only on a single surface on the lower surface 22 or the upper surface 21 of the substrate layer 2. The other companies that have purchased and/or used the structure of the present invention may be able to carry out their own subsequent processing on one side of the second region 5 that have the plurality of metal circuits 42, enabling the formation of a plurality of strips that correspond to the position of the connection circuit 52 of the first region 4. The plurality of strips are seen as long strips of the plurality of metal circuits 42 that are electrically connected to the plurality of connection circuits 52.

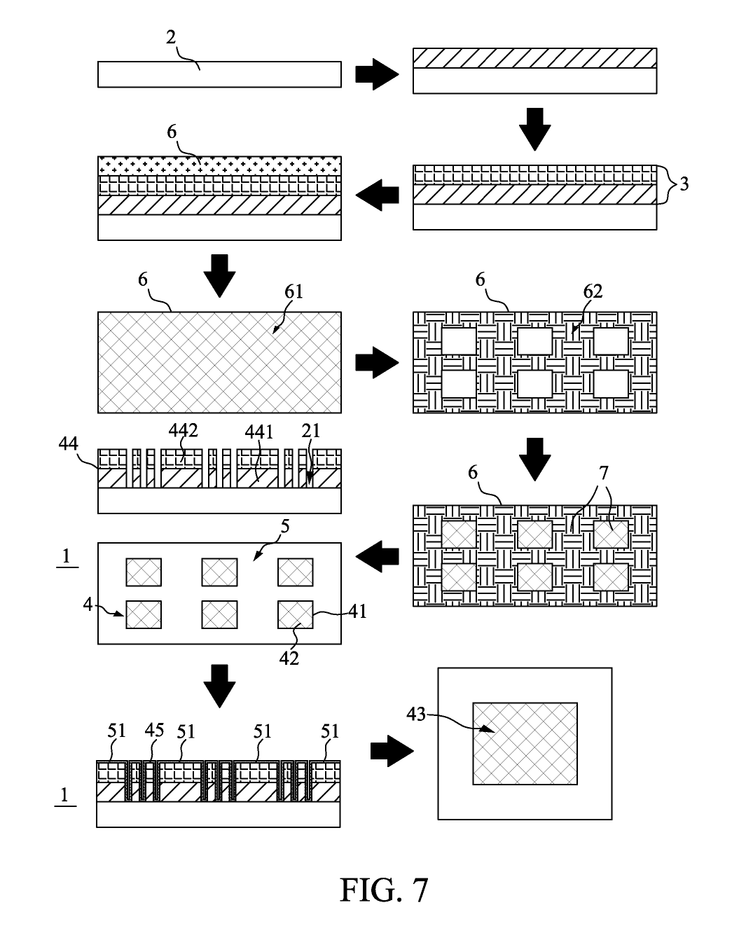

Referring to FIG. 7, the method for manufacturing the touch electrode substrate 1 of the present invention is illustrated in accordance with the second preferred embodiment. The difference of the second preferred embodiment in comparison to the first preferred embodiment lies in the fact that: the size of each of the plurality of metal circuit blocks 41 of the first region 4 may be designed in a manner such that each of the plurality of metal circuit blocks 41 may have the same pattern. The other procedural steps and technical features not mentioned here are the same as those of the first preferred embodiment of the present invention.

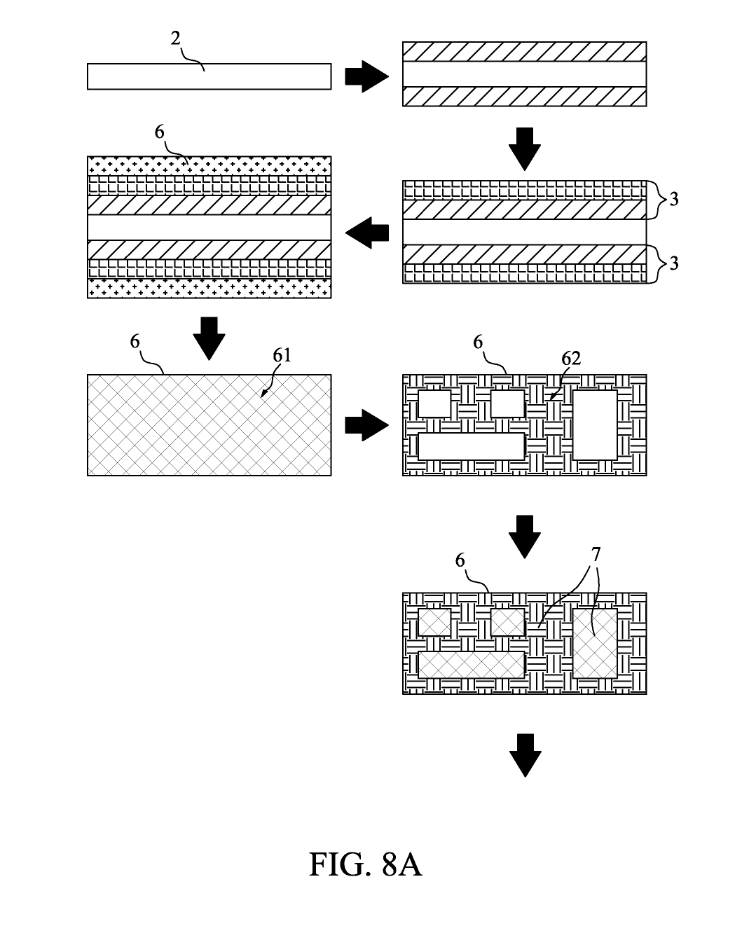

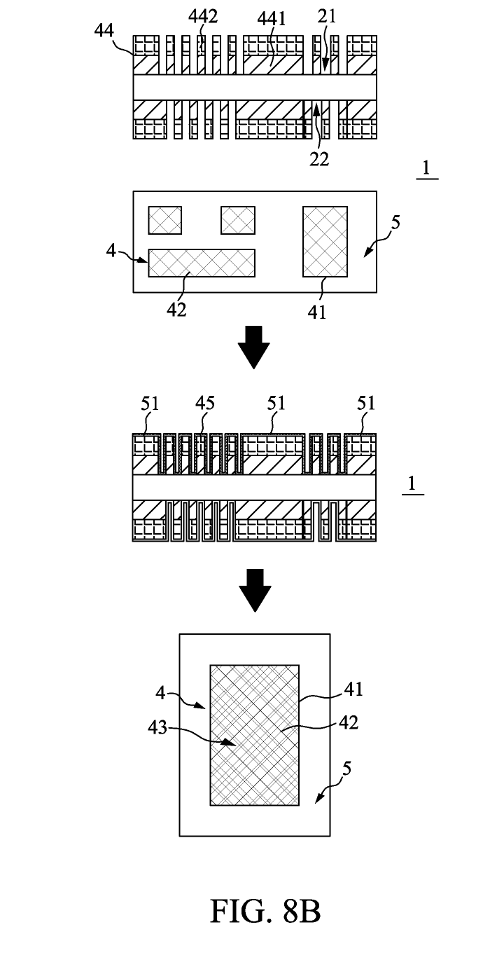

Referring to FIG. 8A and FIG. 8B, the method for manufacturing the touch electrode substrate 1 of the present invention is shown in accordance with the third preferred embodiment. The difference of the third preferred embodiment of the present invention in comparison to the first preferred embodiment lies in the fact that when the metal circuit 42 of the third preferred embodiment may be formed on the upper surface 21 of the substrate layer 2, the metal circuit 42 may also be formed on the lower surface 22 of the substrate layer 2. This leads to the formation of a double-sided structure. As such, the step of adhering two single-sided structures of the first preferred embodiment, and thus allowing the two single-sided structures to overlap, by means of the optically clear adhesive will not be needed. In addition, the other companies may be able to independently carry out the respective subsequent processing on either one side or both sides of connection circuit 52 along the x-axis 521 and the connection circuit 52 along the y-axis 522; or alternatively, processing may be carried out on the connection circuit 52 along the x-axis 521 and along the y-axis 522 at the same time.

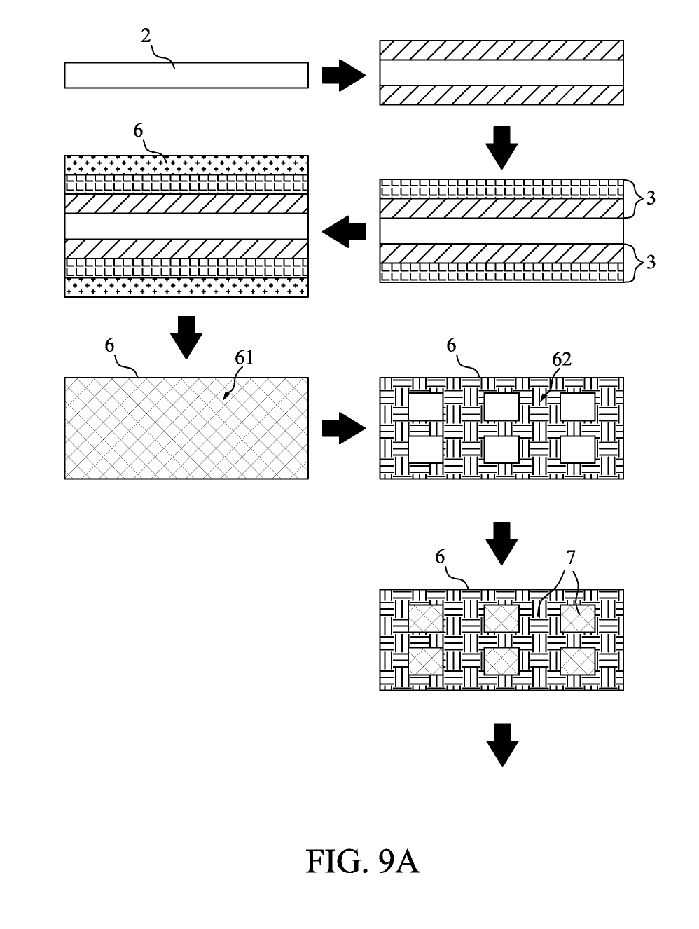

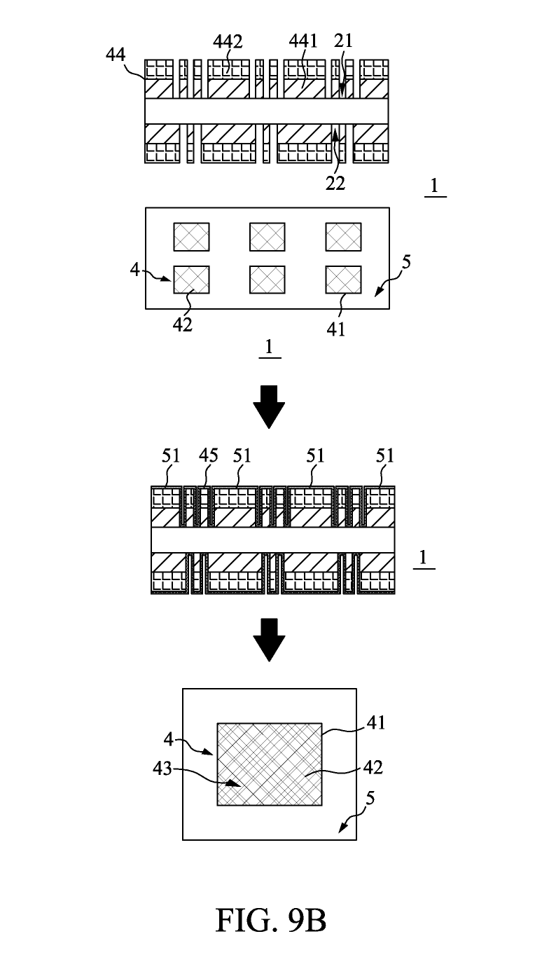

Moreover, referring to FIG. 9A and FIG. 9B, the method for manufacturing the structure for the touch electrode substrate 1 of the present invention is shown in accordance with the fourth preferred embodiment. The difference of the fourth preferred embodiment of the present invention in comparison to the first preferred embodiment lies in the fact that the size of each of the plurality of metal circuit blocks 41 of the first region 4 may be designed in a manner such that each of the plurality of metal circuit blocks 41 of the first region 4 may have the same size. In addition, as to the structure which may be double-sided and may have the plurality of metal circuits 42, the step of adhering two single-sided structures of the first preferred embodiment by means of the optically clear adhesive will not be needed. Moreover, the other companies may be able to independently carry out the respective subsequent processing on either one side or both sides of the plurality of connection circuits 52 along the x-axis 521, or along the y-axis 522; or alternatively, processing may be carried out on the connection circuit 52 along the x-axis 521 and along y-axis 522 at the same time.

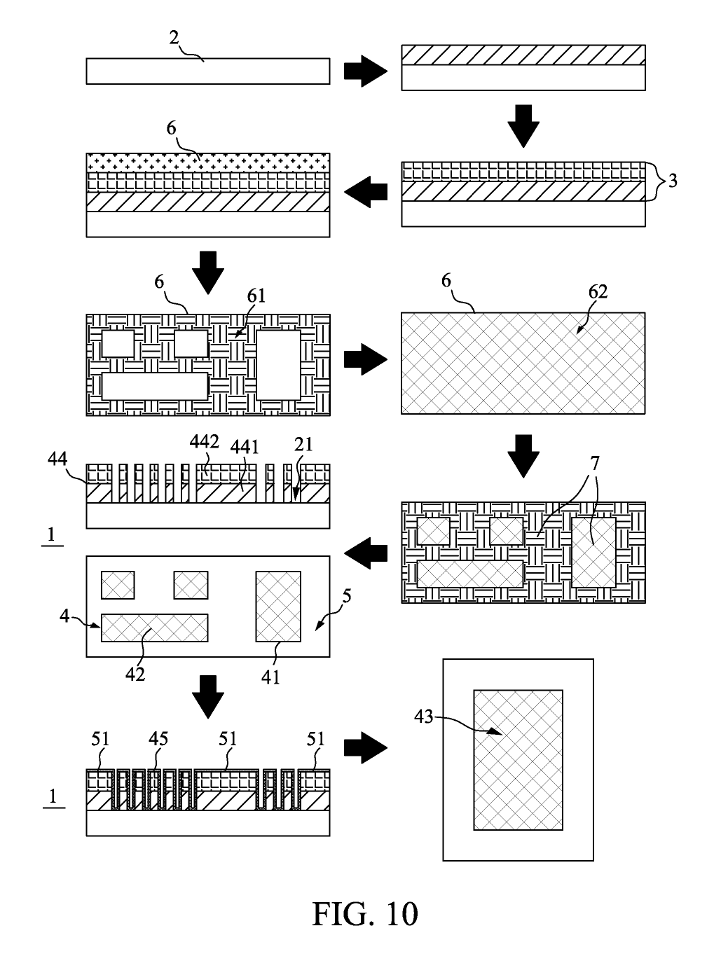

As shown in FIG. 10, the method for manufacturing the touch electrode substrate 1 of the present invention is illustrated in accordance with the fifth preferred embodiment. The difference of the fifth preferred embodiment of the present invention in comparison to the first preferred embodiment lies in the step (C) and the step (D).

In particular, in the step (C) of the method of the present invention, a negative photoresist 6 may be coated and adhered onto the upper surface of the conductive layer 3 by means of a coating method and a adhesive film. The photoresist 6 may be selected from one material from the group consisting of a dry film photoresist, or selected from a negative or positive liquid photoresist material. A first exposure may be performed on the photoresist 6 of the upper surface of the conductive layer 3 by means of a soft plastic film photomask, leading to the formation of a first exposure pattern 61 on the upper surface of the conductive layer 3. The process of the first exposure may involve the exposing of the photoresist of the predetermined pattern that is to be preserved or removed by the use of a plastic film photomask.

A second exposure may be performed by covering a single precise glass photomask on the photoresist 6, and the second exposure pattern 62 may be formed on the photoresist 6 of the upper surface of the conductive layer 3. The second exposure process may involve the formation of a second exposure pattern 62. The second exposure pattern 62 may be formed by means of subjecting ultraviolet light and the photoresist 6 to another exposure, and thus forming a second exposure pattern 62 that can be preserved or removed. Additionally, the second exposure pattern 62 partially may overlap with the first exposure pattern 61.

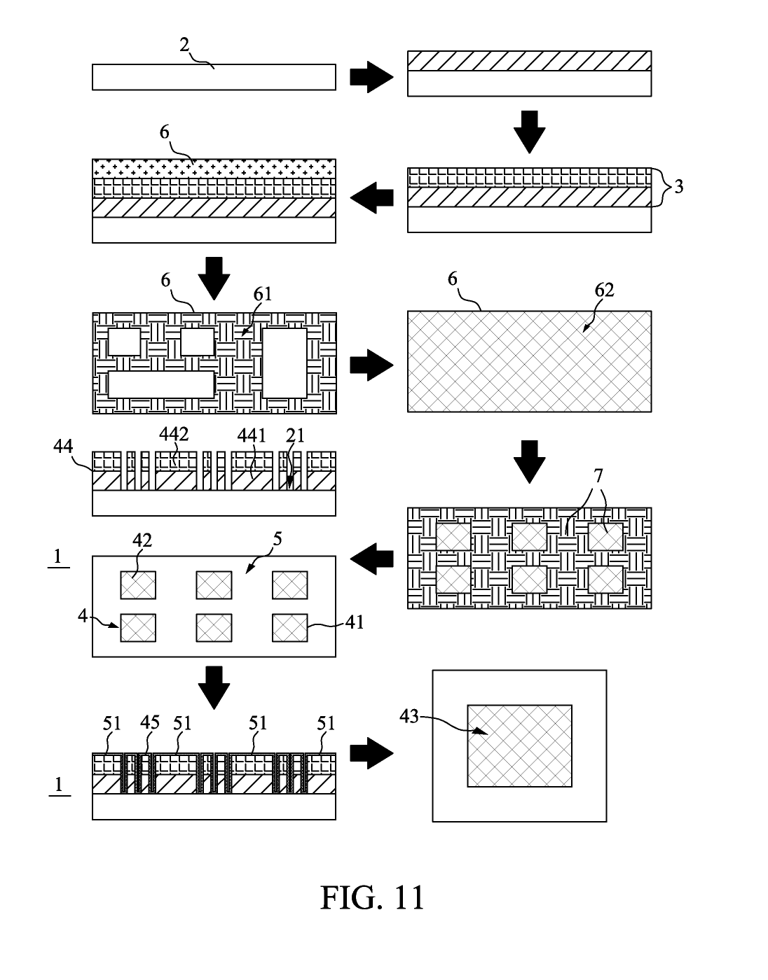

Referring to FIG. 11, the method for manufacturing the touch electrode substrate 1 of the present invention is illustrated in accordance with the sixth preferred embodiment. In comparison to the fifth embodiment of the present invention, the difference of the sixth preferred embodiment of the present invention lies in the fact that the size of each of the plurality of metal circuit blocks 41 of the first region 4 may be designed in a manner such that each of the plurality of metal circuit blocks 41 has the same size. The other procedural steps and technical features not mentioned here are the same as those of the fifth preferred embodiment of the present invention.

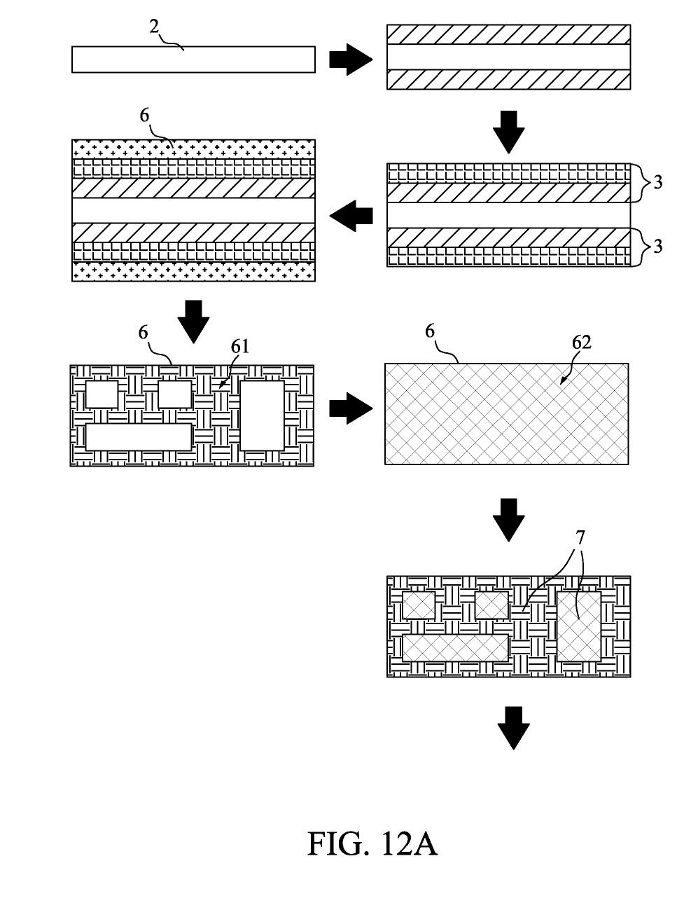

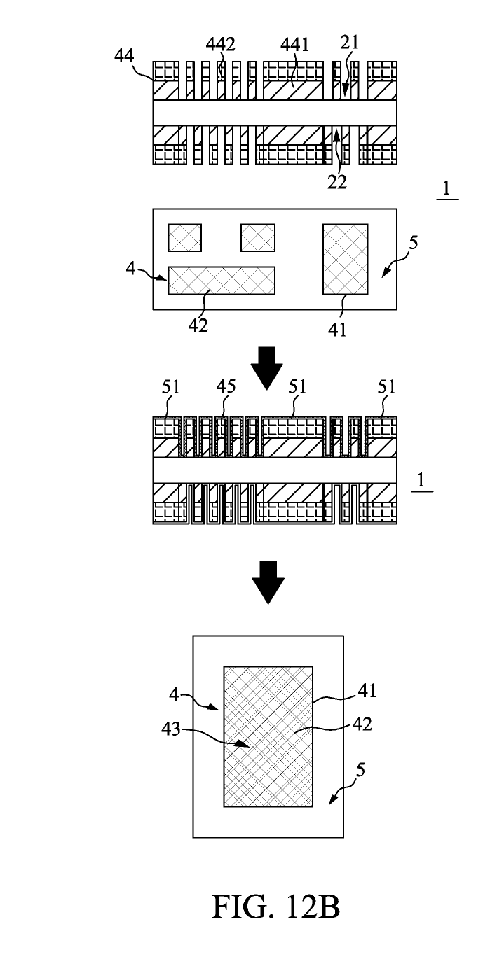

Referring to FIG. 12A to FIG. 12B, the method for manufacturing the touch electrode substrate 1 of the present invention is illustrated in accordance with the seventh preferred embodiment. In comparison to the fifth embodiment of the present invention, the difference of the seventh preferred embodiment of the present invention lies in the fact that the metal circuit 42 may be formed at the same time on the upper surface 21 and the lower surface 22 of the substrate layer 2, thus leading to the formation of a double-sided structure. As a result, the step of adhering two single-sided structures of the previous fifth preferred embodiment of the present invention, and thus allowing the two single-sided structures to overlap, by means of the optically clear adhesive will not be needed. The other companies may be able to independently carry out the respective subsequent processing on either one side or both sides of the plurality of connection circuits 52 along the x-axis 521 or along the y-xis 522; or alternatively, processing may be carried out on the plurality of connection circuits 52 along the x-axis 521 and y-axis 522 at the same time.

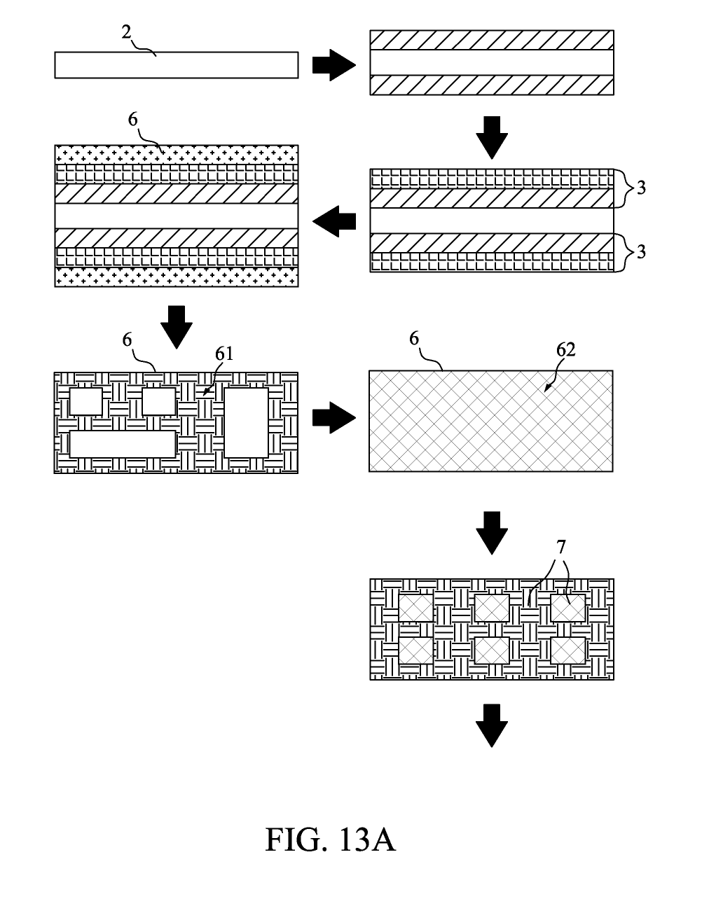

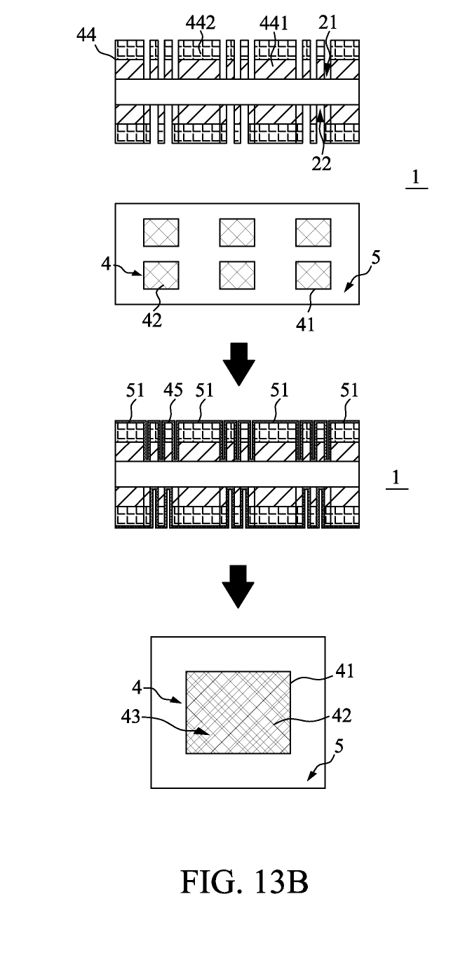

Referring to FIG. 13A to FIG. 13B, the method for manufacturing the touch electrode substrate 1 of the present invention is shown in accordance with the eighth preferred embodiment of the present invention. In comparison to the previous fifth preferred embodiment, the difference of the eighth preferred embodiment of the present invention lies in the fact that the size of each of the plurality of metal circuit blocks 41 of the first region 4 may be designed in a manner such that each of the plurality of metal circuit blocks 41 of the first region 4 has the same size. In addition, due to the fact that the structure of the eighth preferred embodiment of the present invention may be a double-sided structure that has the plurality of metal circuits 42, as such, the step of adhering two single-sided structures of the first preferred embodiment by using the optically transparent adhesive will not be needed. The other companies may be able to independently carry out the respective subsequent processing on either one side or both sides of the plurality of connection circuits 52 along the x-axis 521 or along the y-xis 522; or alternatively, processing may be carried out on the plurality of connection circuits 52 along the x-axis 521 and along the y-axis 522 at the same time.

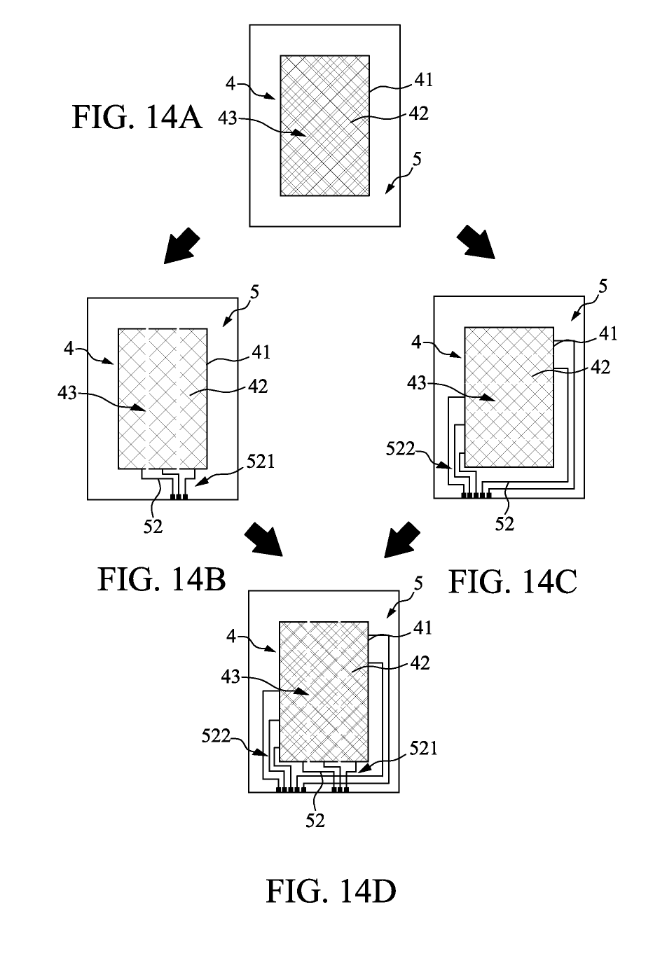

Referring to FIG. 14A to FIG. 14D, the method for manufacturing the structure for touch electrode substrate 1 of the present invention having a single-sided or a double-sided metal circuit 42 is illustrated in accordance with the eighth preferred embodiment. Subsequent to the manufacture of the aforesaid structure for touch electrode substrate 1, and after the purchase of the structure of the present invention, the companies may be able to independently carry out another etching process, to enable etching of the plurality of connection circuits 52 along the x-axis 521 or etching of the plurality of connection circuits 52 along the y-axis. Furthermore, at the same time of etching, the position corresponding to the position of the plurality of connection circuits 52 may be set; and the original and complete plurality of metal circuits 42 which also has a lattice 43 pattern may be etched into a plurality of long strips or a plurality of lattice-shaped strips. Moreover, FIG. 14A shows a structure for the touch electrode substrate 1 manufactured in accordance with the first preferred embodiment and the fifth preferred embodiment of the present invention, as shown (also) in FIG. 6 and FIG. 10, respectively. Also, FIG. 14B shows three of the plurality of connection circuits 52 along the x-axis 521 subsequent to the processing of the structure of FIG. 14A. Furthermore, FIG. 14B also shows three longitudinal long strips of the plurality of metal circuits 42. FIG. 14C shows the processing of five of the plurality of connection circuits 52 along the y-axis 522, as well as showing five of the plurality of metal circuits 42 that appear to be horizontal and in the form of long strips. FIG. 14D shows that a denser circuit pattern may be formed subsequent to the respective processing of the plurality of connection circuits 52 along the x-axis 521 and processing of the plurality of connection circuits 52 along the y-axis; whereby the processing is through the use of an optically clear adhesive. In addition, the touch electrode substrate 1 of the present invention may have the plurality of connection circuits 52 along the x-axis 521 and along the y-axis 522, as well as simultaneously having the double-sided plurality of metal circuit 42. The plurality of metal circuit 42 may be seen visually as a lattice-shaped pattern.

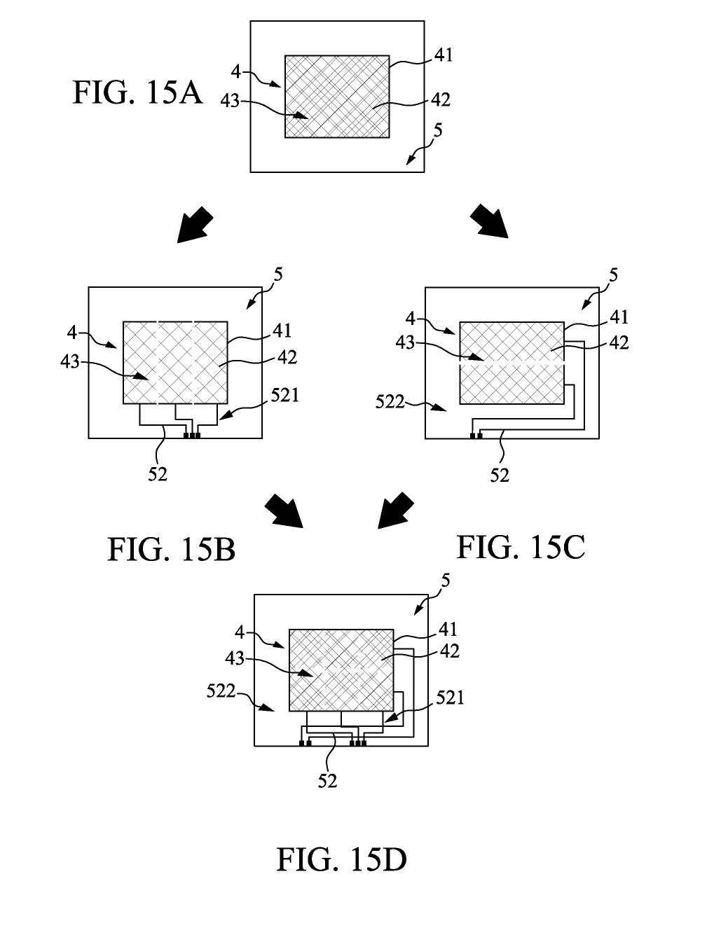

Referring to FIG. 15A to FIG. 15D, FIG. 15A is a schematic diagram illustrating the structure of the touch electrode substrate 1 of the present invention manufactured by means of the second preferred embodiment and the sixth preferred embodiment, as shown in FIG. 7 and FIG. 11, respectively. FIG. 15B shows three of the plurality of connection circuits 52 along the x-axis 521 subsequent to the processing of the structure of FIG. 15A. Furthermore, FIG. 15B also shows three long strips of plurality of metal circuits 42 that may be along the x-axis 521. FIG. 15C shows two of the plurality of connection circuits 52 along the y-axis 522 that have been processed; FIG. 15C also shows two of the plurality of metal circuits 42 that may be along the y-axis 522, and that the plurality of metal circuits 42 appear to be horizontal and in the form of long strips. FIG. 15D shows the subsequent processing of three of the plurality of connective circuits 52 along the x-axis 521 and two of the plurality of metal circuits 52 along the y-axis 522, by means of an optically clear adhesive, and thus leading to the formation of a denser circuit pattern. Moreover, the double-sided plurality of metal circuits 42 of the touch electrode substrate 1 of the present invention may simultaneously have the plurality of connection circuits 52 along the x-axis 521 and along the y-axis 522, and the plurality of metal circuits 42 may be seen visually as a lattice-shaped pattern.

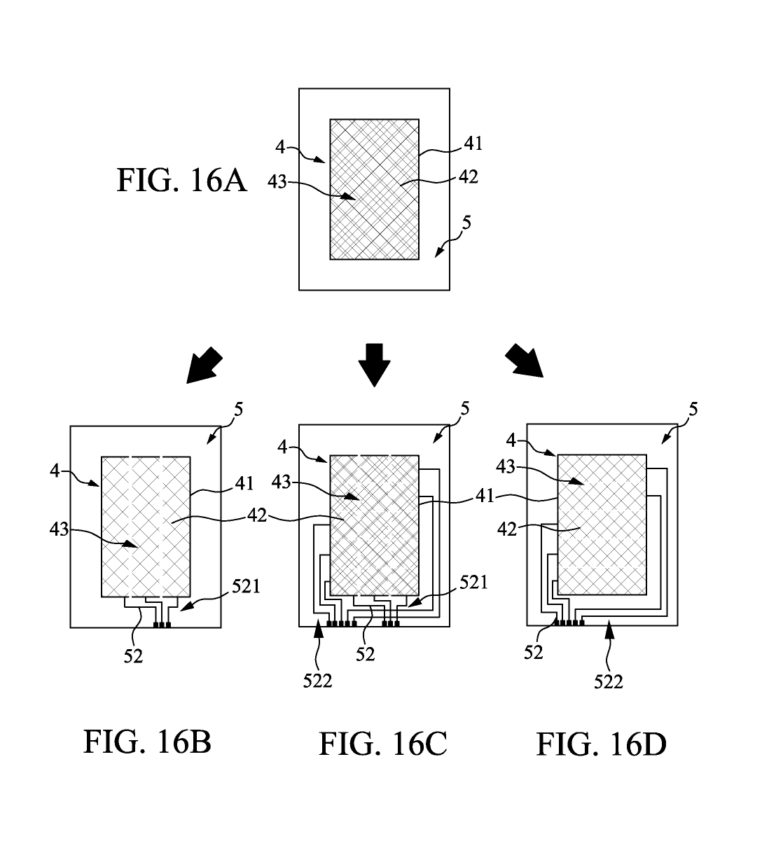

Referring to FIG. 16A to FIG. 16D, FIG. 16A shows a structure for the touch electrode substrate 1 manufactured in accordance with the third preferred embodiment and the seventh preferred embodiment of the present invention, as shown (also) in FIGS. 8A and 8B, and FIGS. 12A and 12B, respectively. FIG. 16B shows the processing of three of the plurality of connection circuits 52 along the x-axis 521. FIG. 16B also shows the processing of three longitudinal long strips of the plurality of metal circuits 42 that may be along x-axis. FIG. 16C shows the simultaneous processing of three of the plurality of connection circuits 52 along the x-axis 521 and five of the plurality of connection circuits 52 along the y-axis 522. The plurality of metal circuits 52 may be seen visually as a lattice-shaped pattern. FIG. 16D shows the processing of five of the plurality of connection circuits 52 along the y-axis 522. In addition, FIG. 16D also shows five long strips of the plurality of metal circuits 42 that are horizontal and along the y-axis 522.

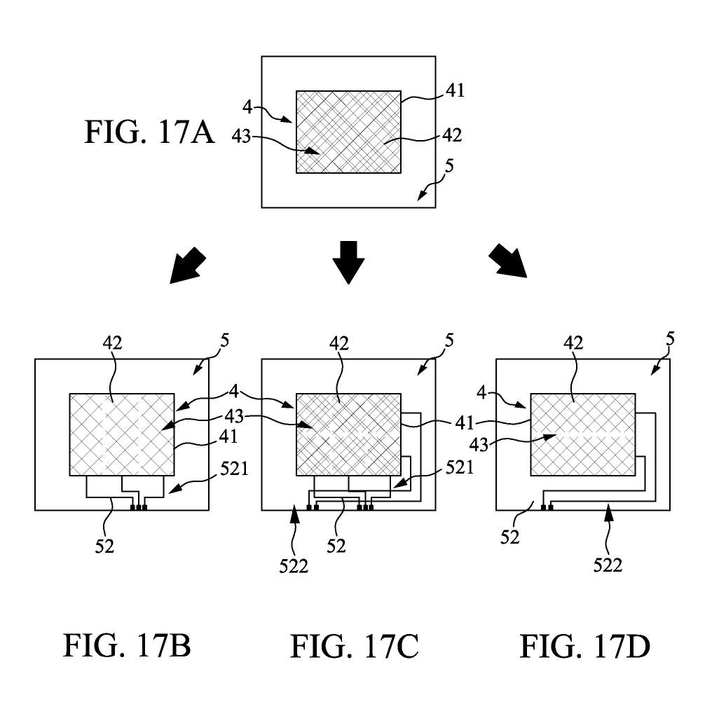

Referring to FIG. 17A to FIG. 17D, FIG. 17A shows a structure for the touch electrode substrate 1 (manufactured) in accordance with the fourth preferred embodiment and the eighth preferred embodiment of the present invention, as shown (also) in FIGS. 9A and 9B, and FIGS. 13A and 13B, respectively. FIG. 17B shows the processing of three of the plurality of connection circuits 52 along the x-axis 521 of the structure of FIG. 17A ; and FIG. 17B also show three long strips of the plurality of metal circuits 42 that are longitudinal and correspond to the x-axis 521. FIG. 17C shows the simultaneous processing of three of the plurality of connection circuits 52 along the x-axis 521 and two of the plurality of connection circuits 52 along the y-axis 522. The plurality of metal circuits 52 may be seen visually as a lattice-shaped pattern. FIG. 17D shows the processing of two of the plurality of connection circuits 52 along the y-axis 522; and FIG. 17D also shows two long strips of the plurality of metal circuits 42 that may be horizontal and that may be along the y-axis 522.

The method for manufacturing the touch electrode substrate of the present invention may involve the design of two continuous exposure procedures, the design of the size and the specific circuit pattern of the substrate structure that is to be manufactured. The touch electrode substrate of the present invention is manufactured through the use of a plurality of low cost and soft plastic film photomasks and a single precise glass photomask; and the touch electrode substrate manufactured may have the preferable properties of being flexible and being bendable, as well as having the plurality of metal circuits with a preset circuit pattern. A plurality of substrates with the plurality of metal circuits that have a single circuit pattern may be manufactured at the same time subsequent to a complete manufacturing process. Moreover, the companies that purchase and/or use the structure of the present invention may be able to carry out additional subsequent processing procedures of the plurality of connection circuits. In particular, such subsequent processing procedures may be carried out on at least one side of the periphery of the plurality of metal circuits of the single substrate, to enable increased usage and design of the structure of the present invention in other circuit boards of electronic products, and thus enabling the corresponding position of the plurality of connection circuits or the plurality of chips to be non-limiting. In other words, the applicability of the present invention in touch electronic products may be significantly increased.

In view of all of the above, as to the exposure process of the present invention, even though two exposure procedures may be performed through the use of a soft plastic film photomask and a single precise glass photomask, the steps of using the soft film photomask and the single precise glass photomask may be swapped. The preferred embodiments of the present invention are not limited to the number of exposure processes that may be performed. In other words, the circuit/trace patterns of the present invention may be maintained or removed by means of using more than two exposure procedures, or by means of a single exposure process. The number of exposure procedures used still fall within the scope of the preferred embodiments of the present invention. Further, in accordance with the preferred embodiments of the present invention, since the method of the present invention may enable the plurality of metal circuits having a precise width to be manufactured, the deviation of the width of each of the plurality of connection circuits and each of the plurality of conductive circuits/traces may be extremely small. That is to say, the width of each of the plurality of connection circuits and each of the plurality of conductive circuits/traces may be manufactured steadily. As such, the method of the present invention may significantly enable the plurality of metal circuits having an extremely precise width to be flexible and bendable, and so as to avoid disconnection of the plurality of metal circuits during the subsequent processing or moving. Accordingly, the conductivity and throughput yield of the overall product may be enhanced in accordance with the preferred embodiments of the present invention.

Although the preferred embodiments of the present invention has been described with reference to the preferred embodiments thereof, it is apparent to a person ordinarily skilled in the art that a variety of modifications and changes may be made without departing from the scope of the present invention which is intended to be defined by the appended claims.

What is claimed is:

1. A structure for a touch electrode substrate comprising:
a substrate layer; and
a conductive layer formed on a surface of the substrate layer, wherein the conductive layer comprises a first region and a second region that is adjacent to the first region, and wherein the first region comprises at least one of a plurality of metal circuit blocks, and each of the plurality of metal circuit blocks comprises a plurality of metal circuits that has a circuit pattern.

2. The structure for the touch electrode substrate according to claim 1, wherein the plurality of metal circuit blocks are mutually arranged and spaced.

3. The structure for the touch electrode substrate according to claim 1, wherein a surface of the plurality of metal circuits of the first region comprises a first weather-resistant layer, and a second weather-resistant layer is formed on a surface of the second region.

4. The structure for the touch electrode substrate according to claim 1, wherein each of the plurality of metal circuits has a width of 0.5 μm to 10 μm.

5. The structure for the touch electrode substrate according to claim 3, wherein the first weather-resistant layer comprises an n-shaped structure.

6. The structure for the touch electrode substrate according to claim 1, wherein the plurality of metal circuits shows a lattice pattern.

7. The structure for the touch electrode substrate according to claim 1, wherein the second region is set to represent a flat block.

8. The structure for the touch electrode substrate according to claim 1, wherein the second region further comprises a plurality of connection circuits that has a circuit pattern, and the circuit pattern of the second region are electrically connected to the plurality of metal circuits of the first region through a plurality of connection circuits.

9. A method for manufacturing a touch electrode substrate, wherein the method comprises the steps of:
(A) selecting a preset substrate for forming a substrate layer;
(B) forming a conductive layer on at least one surface of the substrate layer;
(C) depositing a photoresist on the conductive layer, performing a first exposure, and forming a first exposure pattern on the conductive layer;
(D) performing a second exposure on the conductive layer, and forming a second exposure pattern on the conductive layer;
(E) forming a shielding layer that has a circuit pattern, by means of developing the first exposure pattern and the second exposure pattern; and
(F) processing the conductive layer and the shielding layer, to enable the conductive layer to form a plurality of metal circuits on at least one surface of the substrate layer.

10. The method for manufacturing the touch electrode substrate according to claim 9, wherein the step (F) further comprises a step of forming the plurality of metal circuits by etching on a region that is outside of the shielding layer of the conductive layer.

11. The method for manufacturing the touch electrode substrate according to claim 9, wherein the step (F) further comprises the steps of forming the plurality of metal circuits having the circuits pattern between the shielding layers; and etching the conductive layer that is covered by the shielding layer after removing the shielding layer.

12. The method for manufacturing the touch electrode substrate according to claim 9, wherein the step (F) further comprises a step of forming a weather-resistant layer on the surfaces of the plurality of metal circuits and the conductive layer.

13. The method for manufacturing the touch electrode substrate according to claim 9, the step (C) and the step (D) further comprise the steps of performing a process of the first exposure by means of a precise glass photomask; and performing the process of the second exposure by means of a plastic film photomask.

14. The method for manufacturing the touch electrode substrate according to claim 9, wherein the step (C) and the step (D) further comprise the steps of performing a process of the first exposure by means of a plastic film photomask; and performing a process of the second exposure by means of the precise glass photomask.
